(19) United States
(12) Patent Application Publication
(10) Pub. No.: US 2022/0157316 A1
(43) Pub. Date: May 19, 2022

(54) REAL-TIME VOICE CONVERTER

(71) Applicant: Myna Labs, Inc., San Francisco, CA (US)

(72) Inventor: Yurii Rebryk, Kiev (UA)

(21) Appl. No.: 17/098,385

(22) Filed: Nov. 15, 2020

(51) Int. Cl. G10L 15/26; G10L 25/30; G10L 13/04; G10L 15/02

(52) U.S. Cl. CPC G10L 15/26; G10L 15/02; G10L 13/04; G10L 25/30

(57) ABSTRACT

Provided are systems and methods for real-time voice conversion. An example method includes generating, using an automatic speech recognition model, first embedding vectors from a first spectrum representation of a first speech audio signal of a first person, wherein the first embedding vectors are indicative of sounds present in the first speech audio signal; generating, using a speaker encoder, second embedding vectors from a second speech audio signal of a second person, wherein the second embedding vectors are indicative of voice characteristics of the second person; generating, based on the first embedding vectors and the second embedding vectors, acoustic features; generating, using a decoder, based on the acoustic features, a second spectrum representation; and synthesizing, based on the second spectrum representation and using a vocoder, a synthetic speech audio signal substantially resembling pronunciation of the first speech audio signal by the second person.

### TECHNICAL FIELD

This disclosure generally relates to audio processing. More particularly, this disclosure relates to systems and methods for real-time voice conversion.

### BACKGROUND

Voice conversion (VC) or voice style transfer is a technique that allows modifying speech of one speaker to sound like speech of another speaker. VC has a wide range of practical applications including privacy protection, entertainment content generation, and personalized speech synthesis. Existing solutions for VC require generating a pre-trained automatic speech recognition model to extract linguistic information from a source utterance and a decoder for synthesizing, based on the linguistic information, a new speech sound like a speech sound of a target speaker. The drawback of the existing solutions is that the voice conversion can be performed for the target speaker only by using a training dataset. The existing solutions require re-training the decoder for a new speaker. There is a need for more computationally efficient voice conversion technique not requiring gathering new data when converting the source speech to the speech of another speaker.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one embodiment of the disclosure, a method for real-time voice conversion is provided. The method may include generating, using an automatic speech recognition (ASR) model, first embedding vectors from a first spectrum representation of a first speech audio signal of a first person. The first embedding vectors are indicative of sounds present in the first speech audio signal. The method may include generating, using a speaker encoder, second embedding vectors from a second speech audio signal of a second person. The second embedding vectors are indicative of voice characteristics of the second person. The method may include generating, based on the first embedding vectors and the second embedding vector, acoustic features. The method may include generating, using a decoder, based on the acoustic features, a second spectrum representation. The method may include synthesizing, using a vocoder, based on the second spectrum representation, a synthetic speech audio signal. The synthetic speech audio signal substantially resembles pronunciation of the first speech audio signal by the second person.

The first spectrum representation may include a first mel-spectrogram of the first speech. The second spectrum representation may include a second mel-spectrogram of the synthetic speech audio signal.

The first embedding vectors may substantially lack information concerning voice characteristics of the first person. The generation of acoustic features may include concatenation of the first embedding vectors and the second embedding vector. The generation of acoustic features may include an addition of the first embedding vectors and the second embedding vector.

The ASR model may include a first neural network configured to map the spectrum representation of the first speech audio signal to a sequence of letters. The first neural network may include at least one hidden layer. The first embedding vectors can be obtained as an output of the hidden layer.

The speaker encoder may include a second neural network configured to produce the second embedding vectors from the second speech audio signal.

The decoder can include a third neural network configured to generate the second spectrum representation from the first embedding vectors generated by the at least one hidden layer of the first network. The first embedding vectors can be conditioned by the second embedding vectors produced by the second neural network.

According to another embodiment, a system for real-time voice conversion is provided. The system may include at least one processor and a memory storing processor-executable codes, wherein the at least one processor can be configured to implement the operations of the above-mentioned method for real-time voice conversion upon executing the processor-executable codes.

According to yet another aspect of the disclosure, there is provided a non-transitory processor-readable medium, which stores processor-readable instructions. When the processor-readable instructions are executed by a processor, they cause the processor to implement the above-mentioned method for real-time voice conversion.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a block diagram showing an example environment in which a method for real-time voice conversion can be implemented.

FIG. 2 is a block diagram of a real-time voice conversion system, according to some example embodiments.

FIG. 3 is a block diagram showing a subsystem of a system for real-time voice conversion, according to an example embodiment

FIG. 4 is a flow chart of a method for real-time voice conversion, according to an example embodiment.

FIG. 5 shows an example computer system that can be used to implement the methods for real-time voice conversion.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

This disclosure relates to methods and systems for real-time voice conversion. Some embodiments of the present disclosure may allow real-time modifications of an audio of a first speech of a first speaker to sound like a second speech of a second speaker, where the second speaker is different from the first speaker.

Some embodiments of the disclosure may include an audio encoder, speaker encoder, decoder, and vocoder. The audio encoder can include a first artificial neural network (ANN) for extracting, from a source speech, source speech embeddings. The speaker encoder may include a second ANN for extracting, from a target speech, a fixed dimensional vector that represents speaker embeddings. The decoder may predict a mel-spectrogram using the source embeddings conditioned on the speaker embeddings. The vocoder may then synthesize speech using the mel-spectrogram.

According to an example embodiment of the disclosure, a method for real-time voice conversion may include generating, using an ASR model, first embedding vectors from a first spectrum representation of a first speech audio signal of a first person. The first embedding vectors are indicative of sounds present in the first speech audio signal. The method may include generating, using a speaker encoder, second embedding vectors from a second speech audio signal of a second person. The second embedding vectors are indicative of voice characteristics of the second person. The method may include generating, based on the first embedding vectors and the second embedding vector, acoustic features. The method may include generating, using a decoder, based on the acoustic features, a second spectrum representation. The method may include synthesizing, based on the second spectrum representation and using a vocoder, a synthetic speech audio signal substantially resembling pronunciation of the first speech audio signal by the second person.

Referring now to the drawings, exemplary embodiments are described. The drawings are schematic illustrations of idealized example embodiments. Thus, the example embodiments discussed herein should not be understood as limited to the particular illustrations present herein, rather these example embodiments can include deviations and differ from the illustrations present herein as shall be evident to those skilled in the art.

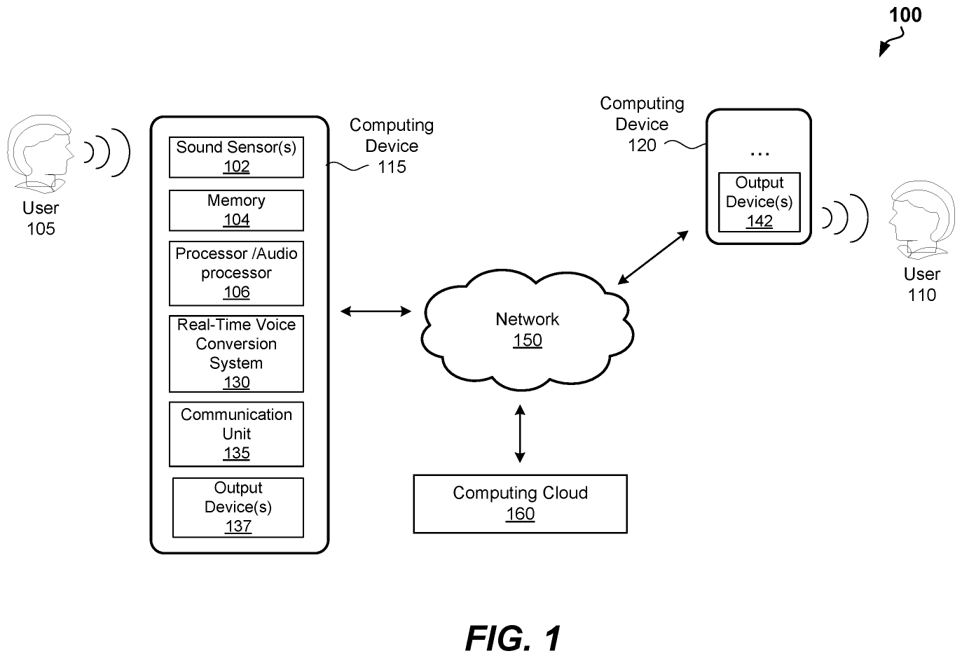

FIG. 1 shows an example environment 100, wherein a method for real-time voice conversion can be practiced. The environment 100 may include a user 105, a user 110, a computing device 115, a computing device 120, a network 150, and a cloud-based computing resource 160 (also referred to as a computing cloud 160). The computing device 115 may include a sound sensor 102, a memory 104, a processor 106, a real-time voice conversion system 130, a communication unit 135, and output device 137.

The memory 104 may be configured to store the real-time voice conversion system 130, including software components and processor-readable (machine-readable) instructions or codes, which when performed by the processor 106, cause the computing device 115 to perform at least some steps of methods for real-time voice conversion as described herein. The processor 106 may perform floating point operations, complex operations, and other operations, including performing speech recognition based on ambient acoustic signals captured by sound sensor(s) 102. The processors 106 may include general purpose processors, video processors, audio processing systems, a central processing unit (CPU), a graphics processing unit (GPU), and so forth.

The sound sensor(s) 102 can include one or more microphones. The sound sensor(s) 102 can be spaced a distance apart to allow the processor(s) 106 to perform a noise and/or echo reduction in received acoustic signals.

In various embodiments, the communication unit 135 can be configured to communicate with a network such as the Internet, wide area network (WAN), local area network (LAN), cellular network, and so forth, to receive and send audio data. In various embodiments, the output device(s) 137 may include any device which provides an audio output to a listener. The output device(s) 137 may comprise one or more speaker(s), an earpiece of a headset, or a handset.

The computing device 115 and computing device 120 can refer to a mobile device such as a mobile phone, smartphone, or tablet computer, a personal computer, laptop computer, netbook, set top box, television device, multimedia device, personal digital assistant, game console, entertainment system, infotainment system, vehicle computer, or any other computing device. The computing device 115 can be communicatively connected to the computing device 120 and the computing cloud 160 via the network 150.

The network 150 can refer to any wired, wireless, or optical networks including, for example, the Internet, intranet, local area network (LAN), Personal Area Network (PAN), Wide Area Network (WAN), Virtual Private Network (VPN), cellular phone networks (e.g., Global System for Mobile (GSM) communications network, packet switching communications network, circuit switching communications network), Bluetooth™ radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the network 150 includes a corporate network, data center network, service provider network, mobile operator network, or any combinations thereof.

In some embodiments, the computing device 120 may include an output device 142 and other components similar to the components of the computing device 115. The computing cloud 160 can include computing resources (hardware and software) available at a remote location and accessible over a network (for example, the Internet). The computing cloud 160 can be shared by multiple users and can be dynamically re-allocated based on demand. The computing cloud 160 can include one or more server farms and clusters including a collection of computer servers which can be co-located with network switches or routers.

According to some embodiments of the present disclosure, the user 105 may communicate with the user 110 by a voice call using a messenger or send voice messages via the messenger. The voice of the user 105 can be captured by the sound sensor 102 of the computing device 115 to generate a speech audio signal. The real-time voice conversion system 130 may modify the speech audio signal to sound like speech of a speaker different from the speaker 105. The modified speech audio signal can be sent, via the communication unit 135, to the computing device 120. The computing device 120 may play back the modified speech audio signal via output device(s) 142. Thus, the user 110 may listen to the modified speech audio signal instead of the voice of the user 105.

In other embodiments, the speech audio signal can be sent to the computing cloud 160. The computing cloud 160 may modify the speech audio signal to sound like a speech of a speaker different from the speaker 105. The computing cloud 160 can send the modified speech audio signal to the computing device 120.

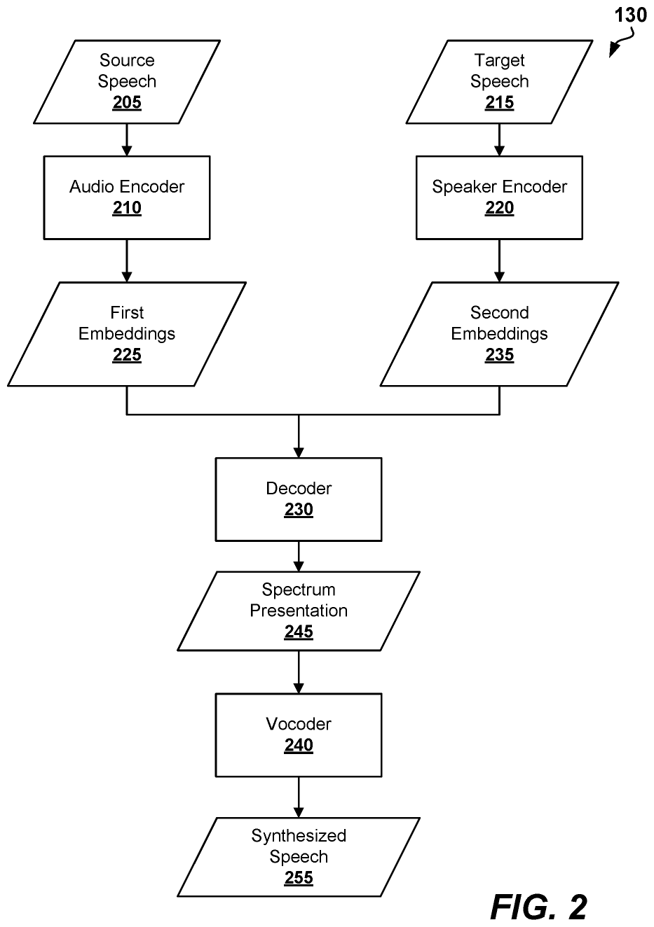

FIG. 2 is a block diagram of the real-time voice conversion system 130, according to an example embodiment. The real-time voice conversion system 130 may include an audio encoder 210, a speaker encoder 220, a decoder 230, and a vocoder 240.

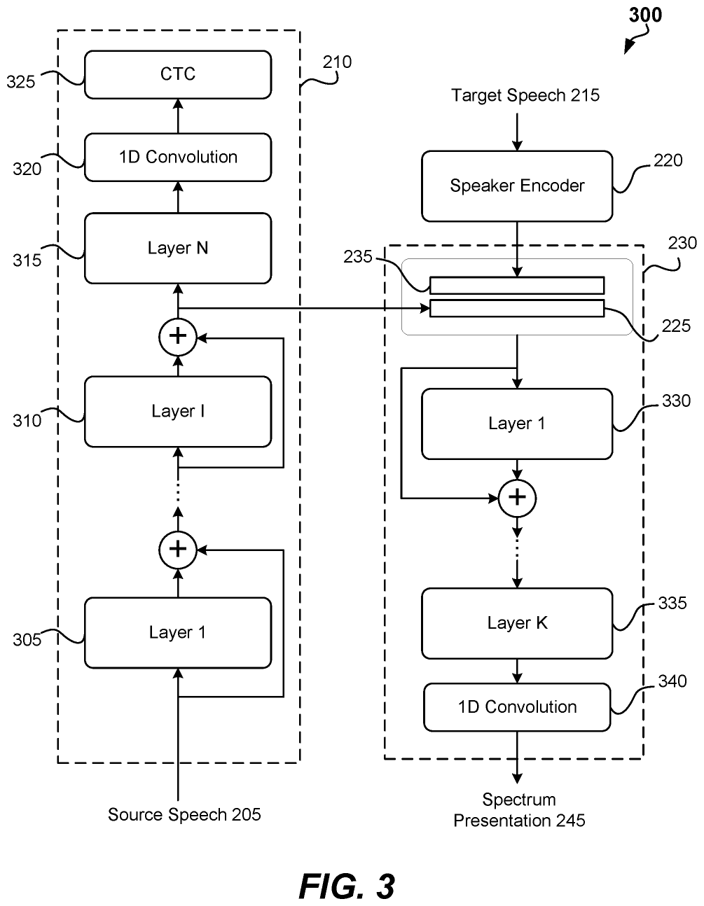

The audio encoder 210 can include a first ANN for extracting, from a source speech 205, first embedding vectors 225 (also referred to as first embeddings 225). The first ANN can be trained to perform automatic speech recognition based on audio signal representing speech. The first ANN can receive, as an input, a spectrum representation of the source speech 205. The spectrum representation can be a mel-spectrogram. The spectrum representation may correspond to a single time frame of the source speech 205. The output of the first ANN can be a letter representation of the time frame of the source speech. However, an output of the audio encoder can be an output of one of hidden layers of the first ANN, where the output of the hidden layer represents embeddings of the time frame of source speech 205. The first embedding vectors 225 can be obtained by determining embeddings consecutively for each time frame of the source speech 205. The first embedding vectors 225 may be indicative of sounds present in the source speech 205. However, the first embedding vectors 225 may lack information concerning voice characteristics of a person who pronounced the source speech 205. Example audio encoder 210 is described in FIG. 3.

The speaker encoder 220 may include a second ANN for extracting, from a target speech 215, second embeddings 235. The second embeddings 235 can be fixed dimensional vectors that represent embeddings of a target speaker. The speaker encoder 220 may include a second ANN trained for extracting embeddings from target speech 215. The second ANN can receive, as an input, spectrum representation of the target speech 215. The spectrum representation can be mel-spectrogram of the target speech 215. The target speech 215 can be pronounced by a person different from the person who pronounced the source speech 205.

The decoder 230 may generate, based on the predicted mel-spectrogram using acoustic features. The acoustic features can be obtained using first embeddings 225 conditioned on second embeddings 235. The decoder 230 may include a third ANN that is trained to generate, based on the acoustic features, a spectrum presentation of a speech (for example, a mel-spectrogram).

The vocoder 240 may synthesize a speech using the mel-spectrogram generated by the decoder 230. In some embodiments, a WaveGlow can be used as the vocoder 240 to synthesize waveforms from mel-spectrograms.

FIG. 3 is a block diagram showing a subsystem 300 of the real-time voice conversion system 130, according to an example embodiment. The subsystem 300 includes the audio encoder 210, the speaker encoder 220, and the decoder 230.

The audio encoder 210 is an ASR model trained to map a mel-spectrogram into a sequence of symbols. The symbols can include one of the following: characters, letters, phonemes, and so forth. The audio encoder 210 can include 1D convolutional layer 320 and blocks 305-315 with residual connections between them. Each of the blocks 305-315 includes the same module that is repeated five times and contains the following layers: a 1D time-channel separable convolutional layer, 2) a batch normalization layer, and 3) a Rectified Linear Unit (ReLU). The output of the audio encoder 210 can be connectionist temporal classification (CTC) 325.

The input of the audio encoder is an 80-channels mel-scale log-magnitude spectrogram with a 1024 window size and a 256 hop, which is normalized separately per each mel channel. Embeddings outputted from intermediate layers can be used by the decoder 230 to synthesize the source speech into another voice. In the example of FIG. 3, embeddings 225 that are produced by the fourth block 310 are used to generate an input to the decoder 230.

The speaker encoder 220 is trained to map a target speech (a short speech utterance) to a vector of fixed dimension (embeddings 235) that captures the characteristics of a target speaker voice. Embeddings 235 can be suitable for conditioning the decoder 230 on speaker identity. The speaker encoder 220 may include a 3-layer long short-term memory (LSTM) network of 256 cells followed by a fully connected layer of 256 units. The speaker encoder can be trained using a generalized end-to-end speaker verification loss that forces the network to produce embeddings with high cosine similarity if utterances belong to the same speaker and low cosine similarity if they do not.

The input to the LSTM network is a 40-channel mel-scale log spectrogram of 1.6 seconds of utterance with a 25 milliseconds window size and 10 milliseconds hop. The output of the LSTM network is L2-normalized output of the top LSTM layer at the final frame. During inference, the target speech can be split into segments of 1.6 seconds overlapping by 50%, which are fed into the speaker encoder 220 encoder separately. The embeddings obtained by the LSTM network are averaged and normalized to form the embeddings 225.

The decoder 230 may generate mel-spectrogram from embeddings 225 conditioned on embedding 235. The decoder 230 may include three blocks 330-335 with residual connections between the blocks. Each of the block 330-335 includes 1D time-channel separable convolution layer, a batch normalization layer, and a ReLU.

The decoder 230 can be trained using a pre-trained audio encoder and a pre-trained speaker encoder. The pre-trained audio encoder extracts source speaker audio embeddings. The pre-trained speaker encoder extracts target speaker embeddings. Parameters of the pre-trained audio encoder and the pretrained speaker encoder can be frozen during the training the decoder 230. The source speaker audio embeddings (embeddings 225) can be concatenated with the target speaker embeddings (embeddings 235) at each time step and fed into the decoder 230. The decoder 230 can be trained using L2 loss.

The output of the decoder 230 can an 80-channel mel-scale log magnitude spectrogram (spectrum presentation 245) having a 1024 window size and a 256 hop that is computed from a 22,050 Hertz audio signal.

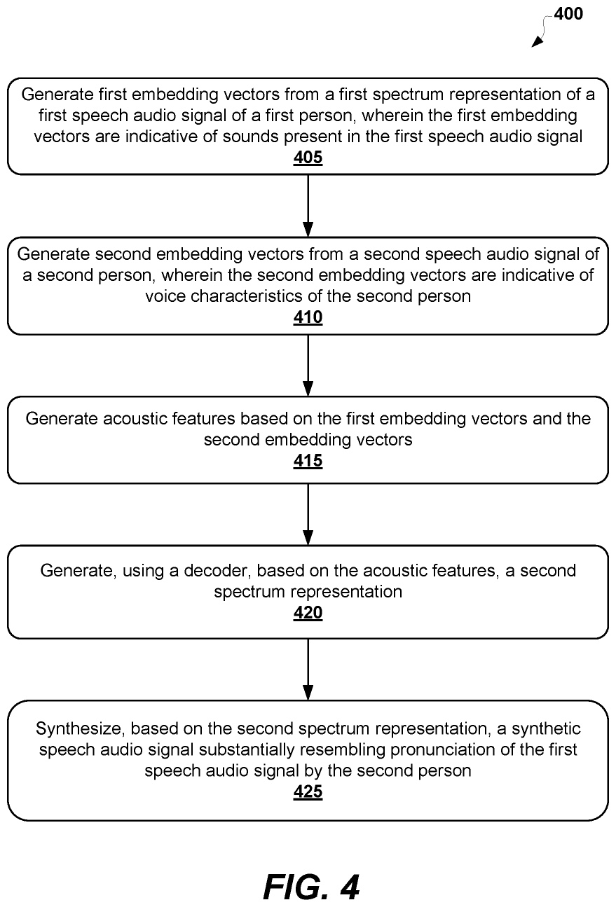

FIG. 4 is a flow chart of a method for real-time voice conversion, according to an example embodiment. The method 400 can be performed by computing device 110.

The method 400 can commence in block 405 with generating, using an ASR model, first embedding vectors from a first spectrum representation of a first speech audio signal of a first person. The first spectrum representation includes a first mel-spectrogram of the first speech. The first embedding vectors are indicative of sounds present in the first speech audio signal. However, the first embedding vectors substantially lack information concerning voice characteristics of the first person.

The ASR model includes a first neural network configured to map the spectrum representation of the first speech audio signal to a sequence of letters. The first neural network may include at least one hidden layer. The first embedding vectors can be obtained as an output of the hidden layer.

In block 410, the method 400 may include generating, using a speaker encoder, second embedding vectors from a second speech audio signal of a second person. The second embedding vectors are indicative of voice characteristics of the second person. The second spectrum representation includes a second mel-spectrogram of the synthetic speech audio signal. The speaker encoder may include a second neural network configured to produce the second embedding vectors from the second speech audio signal.

In block 415, the method 400 may include generating, based on the first embedding vectors and the second embedding vector, acoustic features. The generation of acoustic features may include concatenation of the first embedding vectors and the second embedding vectors. The generation of acoustic features may include addition of the first embedding vectors and the second embedding vectors.

In block 420, the method 400 may include generating, using a decoder, based on the acoustic features, a second spectrum representation. The decoder may include a third neural network configured to generate the second spectrum representation from the first embedding vectors generated by the at least one hidden layer of the first network, where the first embedding vectors are conditioned by the second embedding vectors produced by the second neural network.

In block 420, the method 400 may include synthesizing, using a vocoder, based on the second spectrum representation, a synthetic speech audio signal substantially resembling pronunciation of the first speech audio signal by the second person.

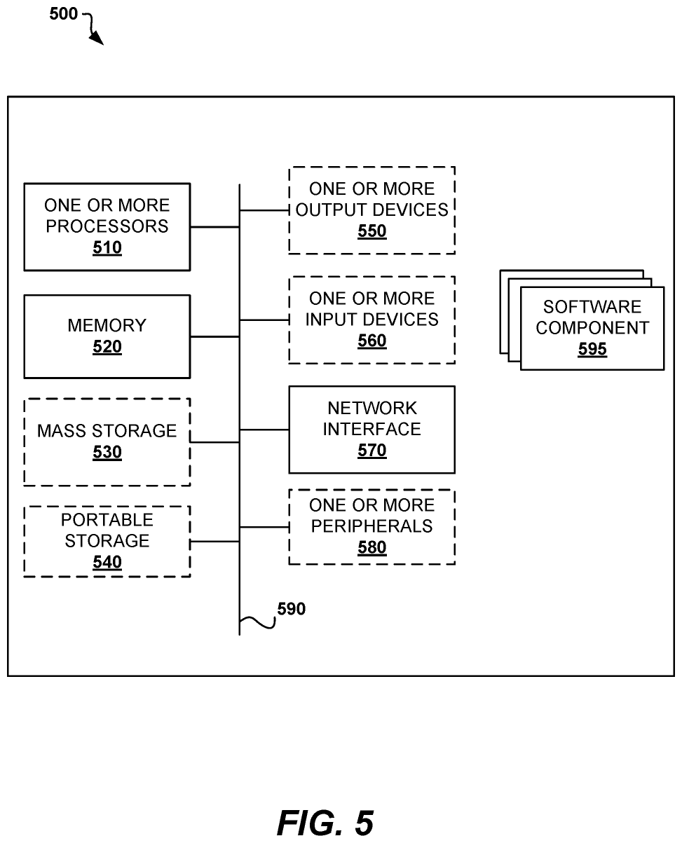

FIG. 5 illustrates an example computing system 500 that may be used to implement methods described herein. The computing system 500 may be implemented in the contexts of the likes of computing devices 115 and 120, real-time voice conversion system 130, and computing cloud 160.

As shown in FIG. 5, the hardware components of the computing system 500 may include one or more processors 510 and memory 520. Memory 520 stores, in part, instructions and data for execution by processor 510. Memory 520 can store the executable code when the system 500 is in operation. The system 500 may further include an optional mass storage device 530, optional portable storage medium drive(s) 540, one or more optional output devices 550, one or more optional input devices 560, an optional network interface 570, and one or more optional peripheral devices 580. The computing system 500 can also include one or more software components 595 (e.g., ones that can implement the method for face reenactment as described herein).

The components shown in FIG. 5 are depicted as being connected via a single bus 590. The components may be connected through one or more data transport means or data network. The processor 510 and memory 520 may be connected via a local microprocessor bus, and the mass storage device 530, peripheral device(s) 580, portable storage device 540, and network interface 570 may be connected via one or more input/output (I/O) buses.

The mass storage device 530, which may be implemented with a magnetic disk drive, solid-state disk drive, or an optical disk drive, is a non-volatile storage device for storing data and instructions for use by the processor 510. Mass storage device 530 can store the system software (e.g., software components 595) for implementing embodiments described herein.

Portable storage medium drive(s) 540 operates in conjunction with a portable non-volatile storage medium, such as a compact disk (CD), digital video disc (DVD), or a flash drive to input and output data and code to and from the computing system 500. The system software (e.g., software components 595) for implementing embodiments described herein may be stored on such a portable medium and input to the computing system 500 via the portable storage medium drive(s) 540.

The optional input devices 560 provide a portion of a user interface. The input devices 560 may include an alphanumeric keypad, such as a keyboard, for inputting alphanumeric and other information, or a pointing device, such as a mouse, a trackball, a stylus, or cursor direction keys. The input devices 560 can also include a camera or scanner. Additionally, the system 500 as shown in FIG. 5 includes optional output devices 550. Suitable output devices include speakers, printers, network interfaces, and monitors.

The network interface 570 can be utilized to communicate with external devices, external computing devices, servers, and networked systems via one or more communications networks such as one or more wired, wireless, or optical networks including, for example, the Internet, intranet, LAN, WAN, cellular phone networks, Bluetooth radio, and an IEEE 802.11-based radio frequency network, among others. The network interface 570 may be a network interface card, such as an Ethernet card, optical transceiver, radio frequency transceiver, or any other type of device that can send and receive information. The optional peripherals 580 may include any type of computer support device to add additional functionality to the computer system.

The components contained in the computing system 500 are intended to represent a broad category of computer components. Thus, the computing system 500 can be a server, personal computer, hand-held computing device, telephone, mobile computing device, workstation, minicomputer, mainframe computer, network node, or any other computing device. The computing system 500 can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium or processor-readable medium). The instructions may be retrieved and executed by the processor. Some examples of storage media are memory devices, tapes, disks, and the like. The instructions are operational when executed by the processor to direct the processor to operate in accord with the disclosure. Those skilled in the art are familiar with instructions, processor(s), and storage media.

It is noteworthy that any hardware platform suitable for performing the processing described herein is suitable for use with the disclosure. The terms “computer-readable storage medium” and “computer-readable storage media” as used herein refer to any medium or media that participate in providing instructions to a processor for execution. Such media can take many forms, including, but not limited to, non-volatile media, volatile media, and transmission media. Non-volatile media include, for example, optical or magnetic disks, such as a fixed disk. Volatile media include dynamic memory, such as system random access memory (RAM). Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, any other memory chip or cartridge, a carrier wave, or any other medium from which a computer can read.

Various forms of computer-readable media may be involved in carrying one or more sequences of one or more instructions to a processor for execution. A bus carries the data to system RAM, from which a processor retrieves and executes the instructions. The instructions received by the system processor can optionally be stored on a fixed disk either before or after execution by a processor.

Thus, the methods and systems for real-time voice conversion have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for real-time voice conversion, the system comprising at least one processor and a memory storing processor-executable codes, wherein the at least one processor is configured to implement the following operations upon execution of the processor-executable codes:
generating, using an automatic speech recognition (ASR) model, first embedding vectors from a first spectrum representation of a first speech audio signal of a first person, wherein the first embedding vectors are indicative of sounds present in the first speech audio signal;
generating, using a speaker encoder, second embedding vectors from a second speech audio signal of a second person, wherein the second embedding vectors are indicative of voice characteristics of the second person;
generating acoustic features based on the first embedding vectors and the second embedding vectors;
generating, using a decoder, based on the acoustic features, a second spectrum representation; and
synthesizing, using a vocoder, based on the second spectrum representation, a synthetic speech audio signal substantially resembling pronunciation of the first speech audio signal by the second person.

2. The system of claim 1, wherein the first spectrum representation includes a first mel-spectrogram of the first speech.

3. The system of claim 1, wherein the second spectrum representation includes a second mel-spectrogram of the synthetic speech audio signal.

4. The system of claim 1, wherein the first embedding vectors substantially lack information concerning voice characteristics of the first person.

5. The system of claim 1, wherein the generation of the acoustic features includes concatenation of the first embedding vectors and the second embedding vectors.

6. The system of claim 1, wherein the ASR model includes a first neural network configured to map the first spectrum representation of the first speech audio signal to a sequence of letters, characters, or phonemes.

7. The system of claim 6, wherein:
the first neural network includes at least one hidden layer; and
the first embedding vectors are obtained as an output of the at least one hidden layer.

8. The system of claim 7, wherein the speaker encoder includes a second neural network configured to produce the second embedding vectors from the second speech audio signal.

9. The system of claim 8, wherein the decoder is a third neural network configured to generate the second spectrum representation from the first embedding vectors generated by the at least one hidden layer of the first network.

10. The system of claim 9, wherein the first embedding vectors are conditioned by the second embedding vectors produced by the second neural network.

11. A computer-implemented method for real-time voice conversion, the method comprising:
generating, using an automatic speech recognition (ASR) model, first embedding vectors from a first spectrum representation of a first speech audio signal of a first person, wherein the first embedding vectors are indicative of sounds present in the first speech audio signal;
generating, using a speaker encoder, second embedding vectors from a second speech audio signal of a second person, wherein the second embedding vectors are indicative of voice characteristics of the second person;
generating, based on the first embedding vectors and the second embedding vectors, acoustic features;
generating, using a decoder, based on the acoustic features, a second spectrum representation; and
synthesizing, using a vocoder, based on the second spectrum representation, a synthetic speech audio signal substantially resembling pronunciation of the first speech audio signal by the second person.

12. The method of claim 11, wherein the first spectrum representation includes a first mel-spectrogram of the first speech.

13. The method of claim 11, wherein the second spectrum representation includes a second mel-spectrogram of the synthetic speech audio signal.

14. The method of claim 11, wherein the first embedding vectors substantially lacks information concerning voice characteristics of the first person.

15. The method of claim 11, wherein the generation of acoustic features includes concatenation of the first embedding vectors and the second embedding vector.

16. The method of claim 11, wherein the ASR model includes a first neural network configured to map the spectrum representation of the first speech audio signal to a sequence of letters, characters, or phonemes

17. The method of claim 16, wherein:
the first neural network includes at least one hidden layer; and
the first embedding vectors are obtained as an output of the at least one hidden layer.

18. The method of claim 17, wherein the speaker encoder includes a second neural network configured to produce the second embedding vectors from the second speech audio signal.

19. The method of claim 18, wherein the decoder is a third neural network configured to generate the second spectrum representation from the first embedding vectors generated by the at least one hidden layer of the first network, the first embedding vectors being conditioned by the second embedding vectors produced by the second neural network.

20. A non-transitory processor-readable medium having instructions stored thereon, which when executed by one or more processors, cause the one or more processors to implement a method for real-time voice conversion, the method comprising:
generating, using an automatic speech recognition (ASR) model, first embedding vectors from a first spectrum representation of a first speech audio signal of a first person, wherein the first embedding vectors are indicative of sounds present in the first speech audio signal;
generating, using a speaker encoder, second embedding vectors from a second speech audio signal of a second person, wherein the second embedding vectors are indicative of voice characteristics of the second person;
generating, based on the first embedding vectors and the second embedding vectors, acoustic features;
generating, using a decoder, based on the acoustic features, a second spectrum representation; and
synthesizing, based on the second spectrum representation and using a vocoder, a synthetic speech audio signal substantially resembling pronunciation of the first speech audio signal by the second person.
